(19) United States
(12) Patent Application Publication
(10) Pub. No.: US 2013/0081713 A1
(43) Pub. Date: Apr. 4, 2013

(54) CAPACITIVE HAND FREE AUTOMATIC MIXING FAUCET AND CONTROL METHOD

(71) Applicant: Ching-Yen HSU, New Taipei City (TW)

(72) Inventor: Ching-Yen HSU, New Taipei City (TW)

(21) Appl. No.: 13/251,577

(22) Filed: Oct. 3, 2011

(51) Int. Cl. F16K 11/00

(52) U.S. Cl. 137/468; 137/625.4

(57) ABSTRACT

A capacitive hand free automatic mixing faucet includes a spout, a flow passage connecting a cold water source and a hot water source to the spout, a mixing valve mounted in the flow passage, one or multiple capacitive sensor groups mounted on the outside of the flow passage and adapted for sensing the presence of an external object and producing a corresponding inductance value, a plurality of electronic valves installed in the flow passage and a control device electrically connected with the capacitive sensor groups and adapted for receiving each inductance value produced by the capacitive sensor group and computing the sum of inductance values or the difference between inductance values received within a predetermined time interval and then comparing the computed value with predetermined threshold value and controlling the electronic valves to regular the flow rate of cold water and hot water subject to the comparison result.

### BACKGROUND OF THE INVENTION

1. Field of the Invention

The present invention relates to faucet technology and more particularly, to a capacitive hand free automatic mixing faucet, which uses a control device to control the operation of independent electronic valves in regulating the flow rate of cold water from a cold water source and hot water from a hot water source subject to triggering of capacitive sensor groups at the surface of the flow passage to fit different requirements. The invention also relates to the control method of the capacitive hand free automatic mixing faucet.

2. Description of the Related Art

In our daily life, we usually use water for cleaning and sanitation, maintaining personal hygiene and cleanliness. In houses and public places, faucets are commonly provided for enabling people to clean hands with running water. Conventional rotary and toggle faucets are easy to use and can regulate the flow rate. However, a user must touch the faucet directly when controlling the supply of water or regulating the flow rate. More particularly, a faucet in a public place may be used and contaminated by many people. Therefore, a faucet in a public place tends to spread diseases. It is not a hygienic to use a faucet in a public place in this manner. When at home, one may be inconvenient to manually open or close the faucet due to certain conditions. In order to improve hygienic problems, induction control faucets are created.

Many induction control faucets are known. The prior art discloses a capacitive touch-controlled automatic faucet comprising: a spout; a passageway that conducts water flow through the spout; a electrically operable valve disposed within the passageway; a manual valve disposed within the passageway in series with the electrically operable valve; a manual handle that controls the manual valve; and a capacitive touch control that is positioned in the spout, where the capacitive touch control toggles the electrically operable valve. The faucet has a manual mode and a hands-free mode. However, this design of faucet simply provides a single water temperature.

Other prior art discloses a hands-free device comprising a sensor, a motor, a pilot valve, a gear train, an arm, and, an override control. The pilot motor opens the pilot valve when an activation signal is received from the sensor. The arm is coupled to the gear train, and the override control is coupled to the arm. The override control is capable of moving the arm between a locked and unlocked configuration. Other prior art discloses a hands-free faucet comprising a conductive sensing plate, a capacitor-based sensor circuit electrically connected to the sensing plate, a non-conductive valve housing having a valve inlet and valve outlet, wherein the valve outlet is operatively connected to the conductive spout; a non-conductive seating ring situated between the valve inlet and the valve outlet; a conductive connector traversing the seating ring; and a grounding wire connecting the capacitor-based sensor circuit to the electrical ground. These designs of hands-free faucet are connected with a cold water source and a hot water source and capable of mixing cold water and hot water. However, these designs of hands-free faucet are not automatically switchable between the automatic mode and the manual mode or to one single water source mode for full automatic application.

Other prior art discloses a faucet comprising a proximity sensor, a logical control, a handle, a spout, and a touch control operably coupled to at least one of the spout and the handle. Other prior art discloses an electronic faucet comprising a spout, a passageway configured to conduct fluid flow through the spout, an electrically operable valve in fluid communication with the passageway, and a controller coupled to the valve. Other prior art discloses a faucet comprising a spout, a passageway, an electrically operable valve, a manual valve, and a manual handle, touch sensors, a capacitive sensor and a controller. Other prior art discloses a water delivery device in fluid communication with at least one source of water positioned below a mounting deck, which comprises a base portion in fluid communication with the at least one source of water, a pull-out wand portion in fluid communication with the base portion and having at least one water output, the pull-out wand portion being moveably between a first position proximate to the base portion and a second position spaced apart from the base portion, a sensor coupled to the pull-out wand portion, a valve interposed between the at least one water output of the pull-out wand portion and the at least one source of water, the valve being operable to permit communication of water provided by the at least one source of water to the at least one water output of the pull-out wand portion in a first configuration and to prevent communication of water provided by the at least one source of water to the at least one water output in a second configuration, and a controller operably coupled to the sensor and operably coupled to the valve, the controller causing the valve to be in the first configuration in response to a first indication from the sensor. Other prior art discloses a water delivery system, which is equipped with an electronic user interface having a first touch slider user input operably coupled to the controller thereof. These designs of water delivery system are capable of mixing cold water and hot water. However, they have a complicated piping system. More than four pipes must be used and connected to the faucet, or the mixing valve must be separated from the faucet, complicating the installation. Further, these designs are not switchable to one single water source automatically. When using cold water or hot water exclusively, the user must operate the faucet manually. Thus, the design is not fully automatic.

Other prior art discloses a faucet comprising faucet valve, valve handle connected to the faucet valve, a spout connected to the faucet valve, a capacitive transducer connected to the faucet valve and the valve handle, and a controller connected to the capacitive transducer. Other prior art discloses a hands-free faucet comprising a proximity sensor, a logical control, a handle, a spout, and a touch control operably coupled to at least one of the spout and the handle. Other prior art discloses a faucet comprising a spout, a passageway, an electrically operable valve, a first manual valve, a first manual handle, and a bypass. The passageway conducts water flow through the spout. The electrically operable valve is disposed within the passageway. The first manual valve disposed within the passageway in series with the electrically operable valve. The first manual handle controls the first manual valve. The bypass has a first end above the electrically operable valve, relative to the water flow, and a second end below the electrically operable valve, such that a portion of the water flow bypasses the electrically operable valve. These designs of faucet eliminate the drawbacks of the aforesaid prior arts, however, they are not capable of mixing cold water with hot water and can simply manually regulate two manual valves when wishing to change the water temperature. When in use, these designs of faucet are not fully automatic. These designs of faucet allow switching to a manual mode. However, the faucets do not provide a full automatic function when switched to the manual mode.

Therefore, it is desirable to provide an automatic faucet, which eliminates the drawbacks of conventional induction type faucet designs of being simply capable of turning on/off the supply of water, having a complicated installation procedure, and being not able to automatically regulate the supply of water and to automatically control the water temperature to fit user's different requirements.

### SUMMARY OF THE INVENTION

The present invention has been accomplished to provide a capacitive hand free automatic mixing faucet, which improves the drawbacks of the aforesaid prior art designs.

It is therefore the primary object of the present invention to provide a capacitive hand free automatic mixing faucet, which includes at least one capacitive sensor group arranged at the outer surface of the flow passage and adapted for generating an inductance value when an external object approaches or touches the faucet, and a control device, which computes the inductance value received from the at least one capacitive sensor group and controls electronic valves to keep their current operating status, to stop the supply of water, or to regulate the flow rate of cold water and/or hot water passing to a spout through a mixing valve subject to the computed result. Thus, the faucet can automatically regulates the water temperature to fit user's different requirements, enhancing operation convenience and saving water consumption.

It is a second object of the present invention to provide a capacitive hand free automatic mixing faucet, wherein upon receipt of multiple inductance values from the at least one capacitive sensor groups, the control device computes the total induction time or the total value of induction and compares the computed value with reference values, and then controls electronic valves to give off water or not to give off water subject to the comparison result, so that the user can regulate the temperature of the output water or clean the faucet automatically without supplying the water or stopping the supply of the water.

It is a third object of the present invention to provide a capacitive hand free automatic mixing faucet, wherein the control device can control the cold water electronic valve and the hot water electronic valve separately subject to the inductance value from each individual capacitive sensor group, thereby regulating the water temperature automatically without the use of a mixing valve.

It is a fourth object of the present invention to provide a capacitive hand free automatic mixing faucet, wherein the control devices computes the inductance value received from each capacitive sensor group and compares the computed value with a system predetermined threshold limit value, and then displays a failure message or switches the system from the automatic mode to the manual mode, or from the manual mode to the automatic mode, when the computed value surpasses the system predetermined threshold limit value, providing maximum application flexibility.

It is a fifth object of the present invention to provide a capacitive hand free automatic mixing faucet, wherein multiple capacitive sensor groups are arranged at the outer surface of the flow passage, and a temperature sensor is installed in the faucet to detect the water temperature. Subject to the induction time sequence or time difference of the sensing operations of the multiple capacitive sensor groups at the outer surface of the flow passage to sense the approaching or touching of an external object and the temperature value received from the temperature sensor, the control device controls the electronic valves to regulate the respective flow rate or to maintain their current operating status so that the user can control the water temperature automatically and regulate the flow rate of the supply of water accurately without changing the water temperature, enhancing operation convenience and saving water consumption.

It is a sixth object of the present invention to provide a capacitive hand free automatic mixing faucet, wherein the control device computes the induction time sequence or time difference of the sensing operations of the multiple capacitive sensor groups at the outer surface of the flow passage to sense the approaching or touching of an external object, and then controls the respective electronic valves to regulate the respective cold water or hot water flow rate subject to the computed result, thereby maintaining the water temperature while regulating the output flow rate.

It is a seventh object of the present invention to provide a capacitive hand free automatic mixing faucet, wherein the control device controls every electronic valve to open or stop the supply of cold water or hot water individually subject to every inductance value received from every individual capacitive sensor group, enabling one single water source to supply water when no water temperature regulation is needed and offering a high flexibility of use.

It is a eighth object of the present invention to provide a capacitive hand free automatic mixing faucet, wherein when the multiple capacitive sensor groups are induced, the control device can display a failure message, or switch the system from the automatic mode to the manual mode or from the manual mode to the automatic mode, enhancing the convenience of use.

### BRIEF DESCRIPTION OF THE DRAWINGS

FIG. 1 is a system block diagram of a capacitive hand free automatic mixing faucet in accordance with a first embodiment of the present invention.

FIG. 2 is a capacitive hand free automatic mixing faucet operating flow chart in accordance with the first embodiment of the present invention.

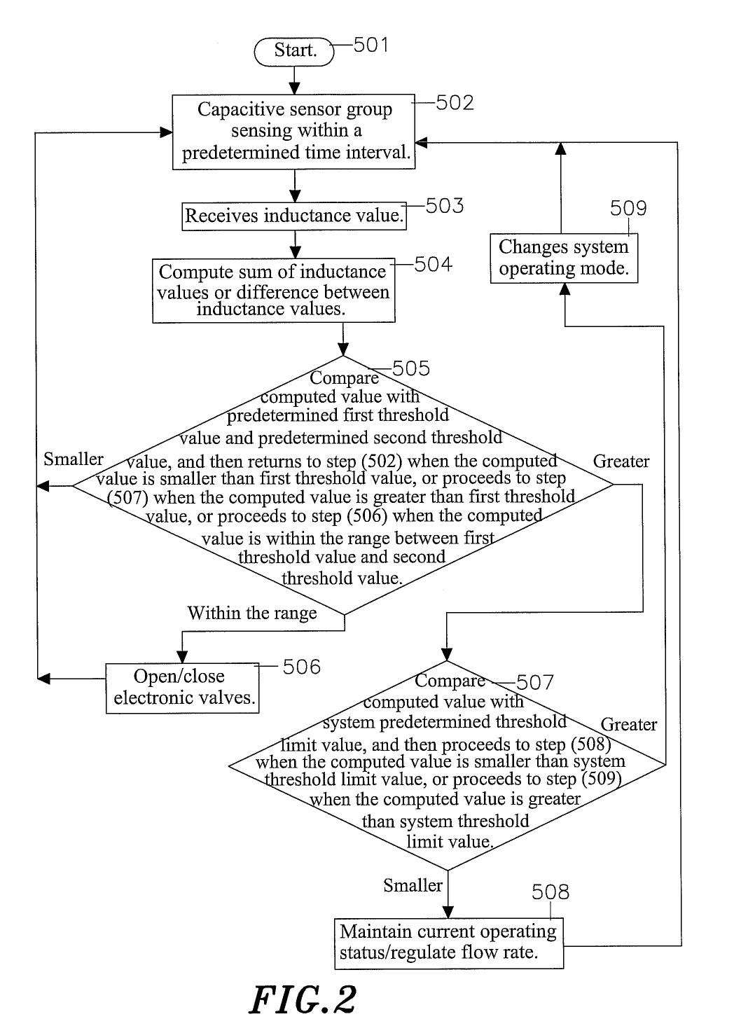

FIG. 3 is a capacitive hand free automatic mixing faucet operating time series diagram in accordance with the first embodiment of the present invention.

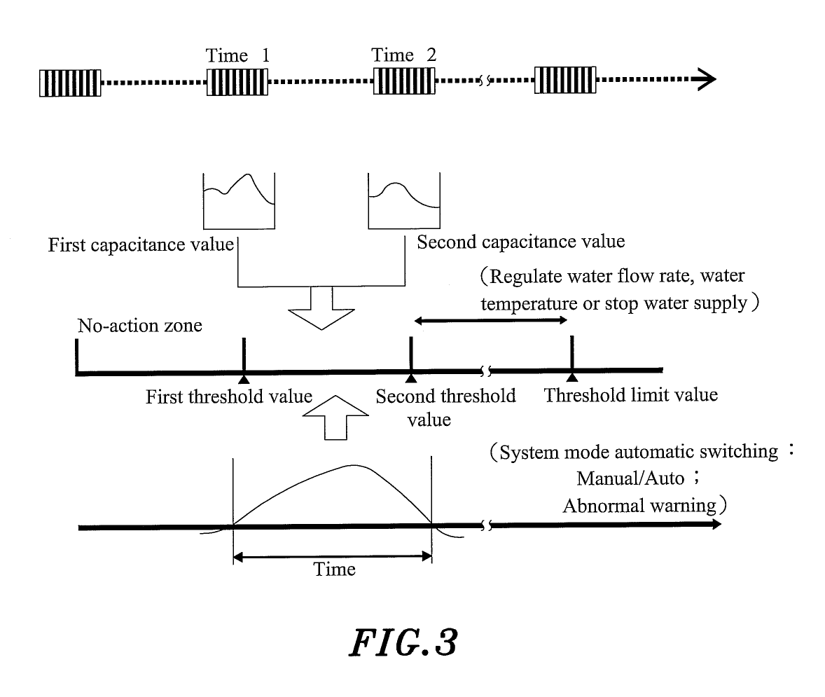

FIG. 4 is a system block diagram of a capacitive hand free automatic mixing faucet in accordance with a second embodiment of the present invention.

FIG. 5 is a schematic top view of the second embodiment of the present invention, illustrating an application example.

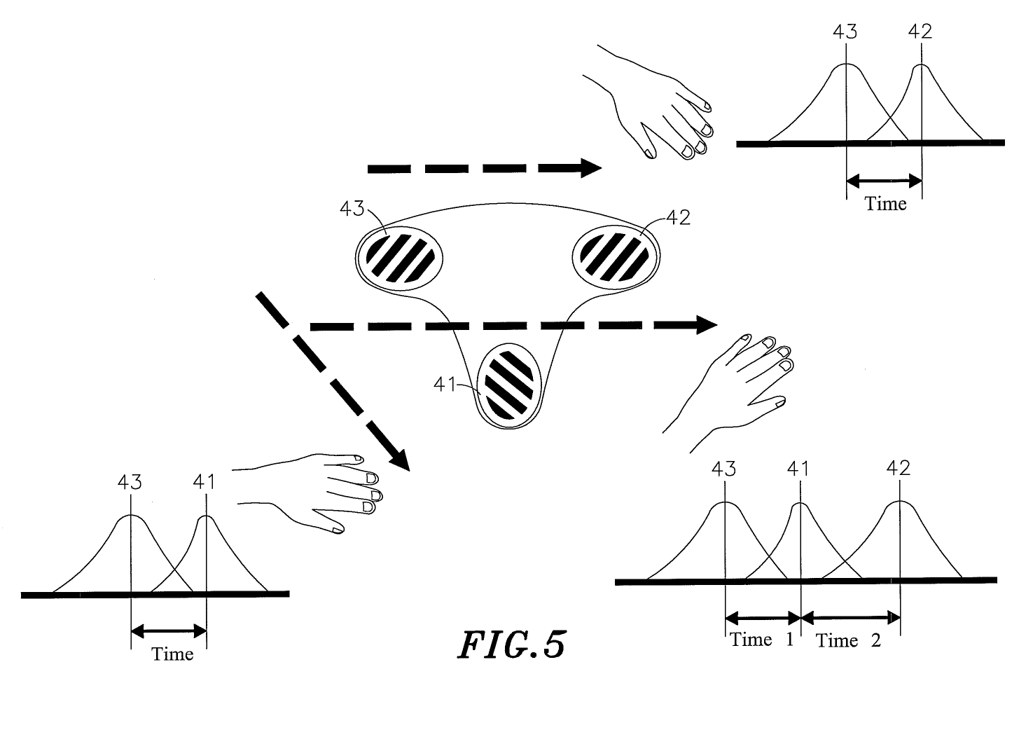

FIG. 6A is a capacitive hand free automatic mixing faucet operating flow chart in accordance with the second embodiment of the present invention (—).

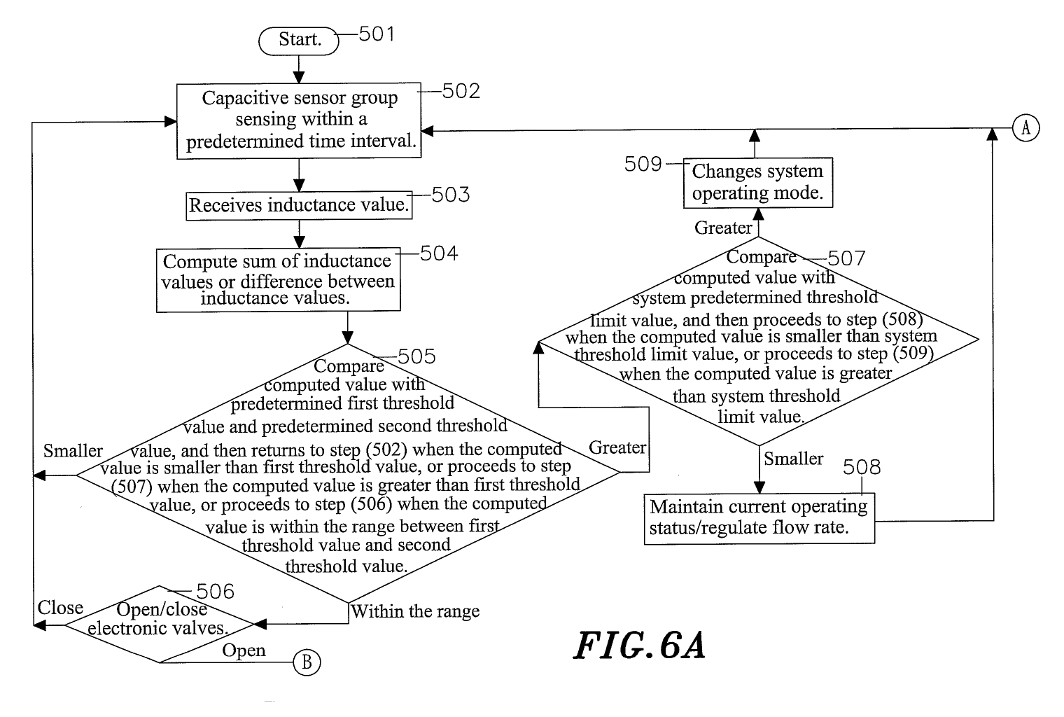

FIG. 6B is a capacitive hand free automatic mixing faucet operating flow chart in accordance with the second embodiment of the present invention ( [symbol] ).

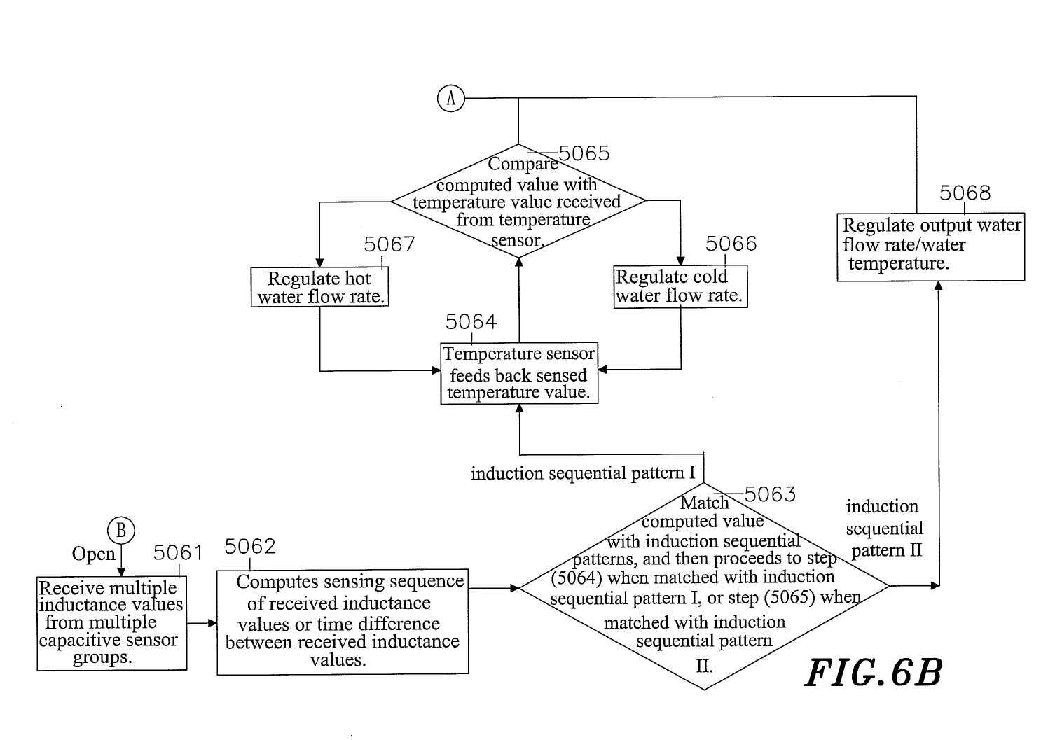

### DETAILED DESCRIPTION OF THE PREFERRED EMBODIMENT

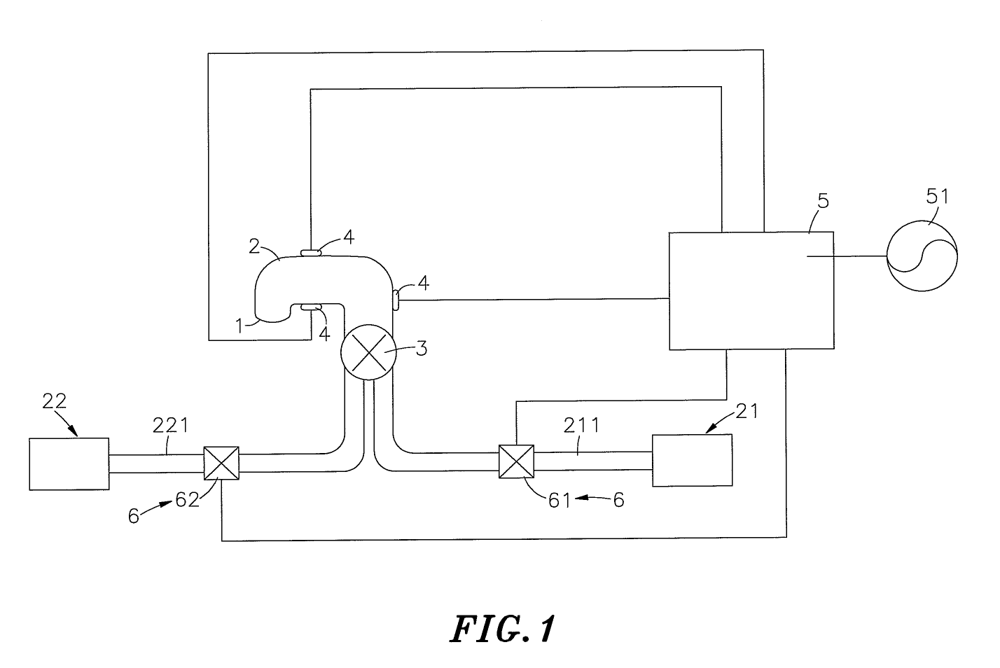

Referring to FIGS. 1˜3, a capacitive hand free automatic mixing faucet in accordance with a first embodiment of the present invention is shown comprising a spout 1, a flow passage 2, a mixing valve 3, at least one capacitive sensor group 4, a control device 5 and a plurality of electronic valves 6.

The spout 1 is connected to the flow passage 2. The flow passage 2 comprises a cold water passage 211 and a hot water passage 221 respectively connected to a cold water source 21 and a hot water source 22. The electronic valves 6 are respectively installed in the cold water passage 211 and the hot water passage 221. According to this embodiment, one cold water electronic valve (for example, electronic flow rate control valve) 61 is installed in the cold water passage 211 and one hot water electronic valve (for example, electronic flow rate control valve) 62 installed in the hot water passage 221. The mixing valve 3 is installed in the flow passage 2 and connected in series with the electronic valves 6. The at least one capacitive sensor group 4 is mounted on the outer surface of the flow passage 2. The control device 5 is electrically coupled with the at least one capacitive sensor group 4, the cold water electronic valve 61 and the hot water electronic valve 62.

The mixing valve 3 is connected in series with the cold water electronic valve 61 and the hot water electronic valve 62, and adapted for mixing cold water from the cold water source 21 and hot water from the hot water source 22 for output through the spout 1.

The at least one capacitive sensor group 4 is adapted for generating an inductance upon approaching of an external object around the flow passage 2 or touching of the flow passage 2 by an external object, and providing the generated inductance to the control device 5.

The control device 5 has a predetermined circuit layout, and adapted for receiving the inductance produced by the at least one capacitive sensor group 4, computing the inductance sum value or difference value within a predetermined time period, comparing the computed value, and controlling the operation of the cold water electronic valve 61 and the hot water electronic valve 62 subject to the comparison result to turn on/off the supply of cold or hot water or to regulate the flow rate of cold or hot water, thereby providing different water-supplying modes (to fit different flow rate, supplying time and water temperature control requirements).

The control device 5 comprises a power source 51 that provides the control device 5 with the necessary working electricity. The power source 51 can be a power adapter, storage battery, fuel battery, water power generator, solar cell or any of a variety of other forms capable of providing the necessary working electricity.

Referring to FIGS. 1˜3 again, multiple different water sources 21;22 (water sources of cold water, hot water, warm water or chilly water) are connected to the flow passage 2; at least one cold water electronic valve 61 and at least one hot water electronic valve 62 are respectively installed in the cold water passage 211 and the hot water passage 221; the mixing valve 3 connects the cold water passage 211 and the hot water passage 221; at least one capacitive sensor group 4 is mounted on the outer surface of the flow passage 2; at least one cold water electronic valve 61 and at least one hot water electronic valve 62 are respectively electrically connected to the control device 5. Thus, based on the sensing operation of the at least one capacitive sensor group 4, the control device 5 controls different water-supplying modes, enabling the mixing valve 3 to provide different water temperature and flow rate to fit user's different requirements

When at least one capacitive sensor group 4 is mounted around the flow passage 2, the at least one capacitive sensor group 4 provides each induced inductance to the control device 5. The control device 5 computes the inductance sum value or difference value of the inductance values received from the capacitive sensors of one same group or different groups within a predetermined time period for comparison with predetermined first threshold value and second threshold value, and then controls the operation of the electronic valves 61;62 in the respective water sources 21;22 to turn on/off the supply of cold, warm, hot or chilly water or to regulate the flow rate of cold, warm, hot or chilly water, thereby providing different water-supplying modes to fit different flow rate, supplying time and water temperature control requirements.

When at least one capacitive sensor group 4 is mounted around the flow passage 2, the at least one capacitive sensor group 4 provides each induced inductance to the control device 5. When any inductance value received from the at least one capacitive sensor group 4 surpasses a predetermined inductance threshold value set in the control device 5, the control device 5 starts calculating the total time in which each capacitive sensor group 4 surpassed the predetermined inductance threshold value and compares the calculated total time with a predetermined induction time threshold value. Subject to the comparison result, the control device 5 controls the operation of the electronic valves 61;62 in the respective water sources 21;22 to maintain the current operating status, to regulate the flow rate or to turn off the supply of cold, warm, hot or chilly water, achieving a variable water-supplying regulation control (water temperature, water flow rate and supplying time regulation controls).

When more than two capacitive sensor groups 4 are mounted around the flow passage 2, the capacitive sensor groups 4 provide induced inductance values to the control device 5. At this time, the control device 5 computes the sum of the inductance values received at two different time points or the difference between the inductance values received at two different time points, and then compares the calculated result with a predetermined threshold value, and then turns on/off one electronic valve 61 or 62 or control the electronic valve 61 or 62 to regulate the flow rate subject to the comparison result.

The control device 5 has a predetermined threshold limit value set therein. When received inductance values from more than two capacitive sensor groups 4, the control device 5 determines whether or not the inductance values surpass the threshold limit value. When the inductance value from one capacitive sensor of one capacitive sensor group 4 surpassed the threshold limit value, the control device 5 can provides a failure message, or opens all the electronic valves 6 and switches them to a manual mode. Alternatively, the control device 5 can be set to switch the electronic valves 6 from the manual mode to an automatic mode when the inductance value from one capacitive sensor of one capacitive sensor group 4 surpassed the threshold limit value.

Further, except the function of mixing cold and hot water, the mixing valve 3 can be configured to provide an additional water flow rate regulating function. When switched to the manual mode, the control device 5 can open all the electronic valves 61;62, and control the mixing valve 3 to regulate the flow rate.

In actual application, the capacitive hand free automatic mixing faucet of this first embodiment runs subject to the following steps:
(501) Start.
(502) At least one capacitive sensor group 4 senses the approaching of an external object around the flow passage 2 or touching of the flow passage 2 by an external object in a predetermined time interval and provides a respective inductance value.
(503) The control device 5 receives each inductance value produced by the at least one capacitive sensor group 4.
(504) The control device 5 computes the sum of inductance values or the difference between inductance values received within a predetermined time period.
(505) The control device 5 compares the computed value with a predetermined first threshold value and a predetermined second threshold value, and then returns to step (502) when the computed value is smaller than said first threshold value, or proceeds to step (507) when the computed value is greater than said first threshold value, or proceeds to step (506) when the computed value is within the range between said first threshold value and said second threshold value.
(506) The control device 5 opens or closes the cold water electronic valve 61 and the hot water electronic valve 62 in the flow passage 2, and then returns to step (502).
(507) The control device 5 compares the computed value with a system predetermined threshold limit value, and then proceeds to step (508) when the computed value is smaller than the system threshold limit value, or step (509) when the computed value is greater than the system threshold limit value.
(508) The control device 5 controls the electronic valves 61;62 to maintain their current operating status or to regulate the flow rate, and then returns to step (502).
(509) The control device 5 changes the system operating mode, and then returns to step (502).

In actual application, the capacitive hand free automatic mixing faucet in accordance with the first embodiment of the present invention has the advantages as follows:
1. By means of the at least one capacitive sensor group 4 on the outer surface of the flow passage 2 to sense the approaching or touching of an external object and to produce a respective inductance value, the control device 5 compares the inductance values with predetermined threshold values and controls the operation of the cold water electronic valve 61 and the hot water electronic valve 62 subject to the comparison result, and therefore the temperature and flow rate of the water outputted through the mixing valve 3 is controlled to fit different requirements, facilitating operation and saving water consumption.
2. Subject to the inductance values provided by the at least one capacitive sensor group 4, the control device 5 computes the total sensing time or the sum of the inductance values received and then determines to keep supplying water or to stop the supplying of water subject to the comparison result so that the user can regulate the temperature of the output water or clean the faucet automatically without supplying the water or stopping the supply of the water.
3. When two or more capacitive sensor groups 4 are mounted on the outer surface of the flow passage 2, the control device 5 can turn on or turn off the supply of the cold water source 21 or hot water source 22 separately subject to the inductance value of the respectively capacitive sensor groups 4, achieving automatic water temperature and flow rate controls without a mixing valve 3.
4. Subject to the inductance values provided by the at least one capacitive sensor group 4, the control device 5 determines whether or not each inductance value surpasses the system predetermined threshold limit value. And then, the control device 5 can display a failure message or switch the electronic valves to a manual mode when the inductance value surpasses the predetermined threshold limit value. The control device 5 can also automatically switches the electronic valves from the manual mode to an automatic mode, offering a high flexibility of use.

In conclusion, the capacitive hand free automatic mixing faucet in accordance with the first embodiment of the present invention has at least one capacitive sensor group 4 mounted on the outer surface of a flow passage 2 to sense the approaching or touching of an external object and to produce a respective inductance value, and a control device 5 electrically connected with the at least one capacitive sensor group 4 for computing the total sensing time of the at least one capacitive sensor group 4 or the sum of the inductance values received from the at least one capacitive sensor group 4 and then compares the sum or difference with a predetermined first threshold value and a second threshold value and then controls the operation of electronic valves 6 subject to the comparison result, and therefore the temperature and flow rate of the water outputted through the mixing valve 3 is controlled to fit different requirements, facilitating operation and saving water consumption.

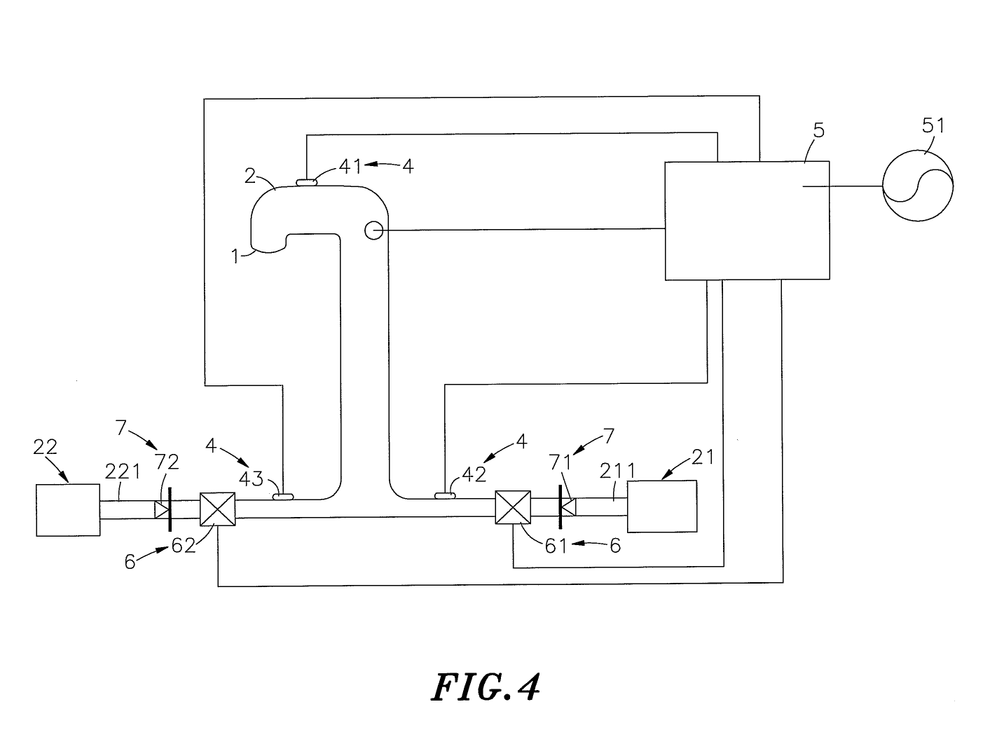

FIGS. 4˜6A and 6B illustrate capacitive hand free automatic mixing faucet in accordance with a second embodiment of the present invention. According to this second embodiment, the capacitive hand free automatic mixing faucet comprises a spout 1, a flow passage 2, check valves 7, temperature sensors 8, a plurality of capacitive sensor groups 4, a control device 5, and a plurality of electronic valves 6 respectively installed in a cold water source and hot water source.

The spout 1 is connected to the flow passage 2. The flow passage 2 defines a cold water passage 211 and a hot water passage 221 respectively connected to a plurality of independent water sources 21;22 (water sources of cold water, hot water, warm water or chilly water). The electronic valves 6 include at least one cold water electronic valve 61 and at least one hot water electronic valve 62. The check valves 7 include at least one cold water check valve 71 and at least one hot water check valve 72. At least one cold water electronic valve 61 and at least one cold water check valve 71 are installed in the cold water passage 211. At least one hot water electronic valve 62 and at least one hot water check valve 72 are installed in the hot water passage 221. The temperature sensors 8 is installed in the flow passage 2 between the spout 1 and the cold water electronic valve 61 and the hot water electronic valve 62. The capacitive sensor groups 4 are mounted on the outer surface of the flow passage 2. According to this second embodiment, the capacitive sensor groups 4 include a first capacitive sensor group 41, a second capacitive sensor group 42 and a third capacitive sensor group 43. The temperature sensors 8, the first capacitive sensor group 41, the second capacitive sensor group 42, the third capacitive sensor group 43, the cold water electronic valve 61 and the hot water electronic valve 62 are respectively electrically connected to the control device 5.

When one of first capacitive sensor group 41, second capacitive sensor group 42 and third capacitive sensor group 43 senses a signal within a predetermined time interval and provides a respective inductance value to the control device 5, the control devices 5 compares the inductance value with a predetermined first threshold value and a predetermined second threshold value, and then controls the cold water electronic valve 61 and the hot water electronic valve 62 to switch between the open position and the close position subject to the comparison result. Subject to the sensing sequence of the first capacitive sensor group 41, the second capacitive sensor group 42 and the third capacitive sensor group 43 or the related time difference of the sensing operations of the capacitive sensor groups 41;42;43, the control device 5 controls regulation of water temperature and flow rate and adjustment of water supplying time to fit different requirements for different users.

When receiving inductance values from the first capacitive sensor group 41, the second capacitive sensor group 42 and the third capacitive sensor group 43 during the operation of the cold water electronic valve 61 and the hot water electronic valve 62 to supply cold water or hot water, the control device 5 computes the sensing sequence of the first capacitive sensor group 41, the second capacitive sensor group 42 and the third capacitive sensor group 43 or the related time difference of the sensing operations of the capacitive sensor groups 41;42;43, and then compares the computed value with system predetermined threshold values. At the same time, the control device 5 receives the temperature value detected by the temperature sensor 8 in the flow passage 2. Subject to the comparison results, the control device 5 controls the cold water electronic valve 61 and the hot water electronic valve 62 to maintain the current operating status, to regulate the flow rate of cold water from the cold water source 21 or hot water from the hot water source 22 or to turn off the supply of cold water or hot water, achieving a variable water-supplying regulation control (regulation of the ratio between cold water and hot water, water flow rate and water supplying time).

The control device 5 can also compute the time difference or sensing sequence of the sensing operations of different combinations of the induction values first capacitive sensor group 41, the second capacitive sensor group 42 and the third capacitive sensor group 43 and the temperature value received from the temperature sensor 8 in the flow passage 2, and then controls the cold water electronic valve 61 and the hot water electronic valve 62 to synchronously regulate the flow rate of cold water from the cold water source 21 and the flow rate of hot water from the hot water source 22.

In actual application, the capacitive hand free automatic mixing faucet of this second embodiment runs subject to the following steps:
(501) Start.
(502) The capacitive sensor groups 4 respectively sense the approaching of an external object around the flow passage 2 or touching of the flow passage 2 by an external object in a predetermined time interval and respectively provide a respective inductance value.
(503) The control device 5 receives inductance values produced by two or more capacitive sensor groups 4.
(504) The control device 5 computes the sum of inductance values or the difference between inductance values received within a predetermined time period.
(505) The control device 5 compares the computed value with a predetermined first threshold value and a predetermined second threshold value, and then returns to step (502) when the computed value is smaller than said first threshold value, or proceeds to step (507) when the computed value is greater than said first threshold value, or proceeds to step (506) when the computed value is within the range between said first threshold value and said second threshold value.
(506) The control device 5 opens the electronic valves 61;62 in the flow passage 2 and then proceeds to step (5061), or closes the electronic valves 61;62 in the flow passage 2 and then returns to step (502).
(5061) The control device 5 receives inductance values produced by two or more of the capacitive sensor groups 41;42;43.
(5062) The control device 5 computes the sensing sequence of the received inductance values or the time difference between the received inductance values.
(5063) The control device 5 matches the computed value with induction sequential patterns, and then proceeds to step (5064) when matched with the induction sequential pattern I, or proceeds to step (5068) when matched with the induction sequential pattern II.
(5064) The temperature sensor 8 provides the sensed temperature value to the control device 5.
(5065) The control device 5 compares the computed value with the temperature value received from the temperature sensor 8, and then proceeds to step (5066) when regulation of cold water flow rate is needed (when the computed value is greater than the temperature value), or proceeds to step (5067) when regulation of hot water flow rate is needed (when the computed value is smaller than the temperature value), or returns to step (502) when the computed value is equal to the temperature value.
(5066) The control device 5 controls the cold water electronic valve 61 to regulate the flow rate of cold water, and then returns to step (5064).
(5067) The control device 5 controls the hot water electronic valve 62 to regulate the flow rate of hot water, and then returns to step (5064).
(5068) The control device 5 controls regulation of water flow rate or water temperature subject to the settings of the induction sequential pattern II, and then returns to step (502).
(507) The control device 5 compares the computed value with a system predetermined threshold limit value, and then proceeds to step (508) when the computed value is smaller than the system threshold limit value, or proceeds to step (509) when the computed value is greater than the system threshold limit value.
(508) The control device 5 controls the electronic valves 61;62 to maintain their current operating status or to regulate the flow rate, and then returns to step (502).

In actual application, the capacitive hand free automatic mixing faucet in accordance with this second embodiment has the advantages as follows:
1. By means of the multiple capacitive sensor groups 4 on the outer surface of the flow passage 2 to sense the approaching or touching of an external object and to produce a respective inductance value, the control device 5 computes the induction time sequence of the sensing operations of the capacitive sensor groups 4 or the time difference between the sensing operations of the capacitive sensor groups 4 and controls the cold water electronic valve 61 and the hot water electronic valve 62 to regulate the flow rate of cold water from the cold water source 21 or hot water from the hot water source 22 or to maintain their current operating status subject to the computed result; after mixing of cold water and hot water, the temperature sensor 8 provides the sensed temperature value to the control device 5, enabling the control device 5 to regulate the operation of the electronic valves 6 subject to the feedback temperature data from the temperature sensor 8, achieving accurate and automatic temperature control, facilitating operation and saving water consumption.
2. Subject to the induction time sequence or time difference of the sensing operations of the multiple capacitive sensor groups 4 at the outer surface of the flow passage 2 to sense the approaching or touching of an external object, the control device 5 controls the cold water electronic valve 61 and the hot water electronic valve 62 to regulate the flow rate of cold water from the cold water source 21 or hot water from the hot water source 22 or to maintain their current operating status subject to the computed result so that the user can regulate the flow rate of the supply of water without changing the water temperature.
3. When multiple capacitive sensor groups 4 are mounted on the outer surface of the flow passage 2, the control device 5 can turn on/off the supply of the cold water source 21 or the hot water source 22 separately subject to the inductance value of the respective capacitive sensor group 4, enabling one single water source to supply the water.
4. When the multiple capacitive sensor groups 4 produce an inductance value at one same time, the control device 5 can displays a failure message or switch the electronic valves from the manual mode to the automatic mode or from the automatic mode to the manual mode.

In conclusion, the invention provides a capacitive hand free automatic mixing faucet and control method, which comprises multiple capacitive sensor groups 4 arranged at the outer surface of a flow passage 2 to sense approaching or touching of an external object and to produce a respective inductance value, and a temperature sensor 8 arranged in the flow passage 2 to sense the temperature of water in the flow passage 2, and a control device 5 electrically connected with the capacitive sensor groups 4 and the temperature sensor 8 and adapted for controlling a cold water electronic valve 61 and a hot water electronic valve 62 to regulate the flow rate of cold water from a cold water source 21 or hot water from a hot water source 22 or to maintain their current operating status subject to the result of computing of the induction time sequence or time difference of the sensing operations of the multiple capacitive sensor groups 4 and the feedback temperature data from the temperature sensor 8 so that the faucet accurately and automatically supplies water subject to the water temperature and water flow rate set by the user.

Although particular embodiments of the invention have been described in detail for purposes of illustration, various modifications and enhancements may be made without departing from the spirit and scope of the invention.

What the invention claimed is:

1. A capacitive hand free automatic mixing faucet, comprising:
a spout;
a flow passage connected to said spout, said flow passage defining a cold water passage connected to a cold water source and a hot water passage connected to a hot water source;
a mixing valve mounted in said flow passage;
at least one capacitive sensor group mounted at an outer surface of said flow passage and adapted for sensing the presence of an external object and producing a corresponding inductance value;
a plurality of electronic valves respectively installed in said cold water passage and said hot water passage and controllable to regulate the flow rate of cold water passing from said cold water source through said cold water passage to said mixing valve toward said spout and the flow rate of hot water passing from said hot water source through said hot water passage to said mixing valve toward said spout; and
a control device electrically connected with said at least one capacitive sensor group and adapted for receiving the inductance value produced by said at least one capacitive sensor group and controlling said electronic valves to regular the flow rate of cold water and the flow rate of hot water subject to the inductance value received from said at least one capacitive sensor group.

2. The capacitive hand free automatic mixing faucet as claimed in claim 1, wherein said control device receives every induction value from said at least one capacitive sensor group and computes the sum of multiple inductance values or difference between inductance values received within a predetermined time interval and compares the computed value with a predetermined first threshold value and a predetermined second threshold value, and gives no control when the computed value is smaller than said predetermined first threshold value, or controls said electronic valves to regulate the flow rate of cold water or hot water when the computed value is greater than said predetermined second threshold value, or switches said electronic valves between an open position and a close position when the computed value is within the range between said predetermined first threshold value and said predetermined second threshold value.

3. The capacitive hand free automatic mixing faucet as claimed in claim 1, wherein said control device receives every induction value from said at least one capacitive sensor group and compares each received inductance value with a predetermined inductance threshold value and starts counting time when the received inductance value surpasses the predetermined inductance threshold value, and then compares the counted time value with a predetermined first time threshold value and a predetermined second time threshold value, and then controls said electronic valves to maintain their current operating status when the counted time value is smaller than said predetermined first time threshold value or greater than said predetermined second time threshold value, or controls said electronic valves to switch between an open position and a close position when the counted time value is within the range between said predetermined first time threshold value and said predetermined second time threshold value.

4. The capacitive hand free automatic mixing faucet as claimed in claim 1, wherein said control device receives every induction value from said at least two capacitive sensor groups and computes the sum of multiple inductance values or difference between the inductance values received within multiple predetermined time intervals and compares the computed value with a predetermined threshold value, and switches one said electronic valve between a close position and an open position or regulates the flow rate of one said electronic valve when the computed value is greater than said predetermined threshold value.

5. The capacitive hand free automatic mixing faucet as claimed in claim 1, wherein said control device receives every induction value from said at least one capacitive sensor group and compares the received inductance value with a system predetermined threshold limit value, and then displays a failure message or switches the system between a manual mode and an automatic mode when the received inductance value surpasses said system predetermined threshold limit value.

6. The capacitive hand free automatic mixing faucet as claimed in claim 1, wherein said mixing valve has the functions of mixing cold water and hot water, regulating water flow rate and switching on/off the supply of water.

7. The capacitive hand free automatic mixing faucet as claimed in claim 1, wherein each said electronic valve has the functions of regulating the flow rate of water passing therethrough and stopping the supply of water.

8. The capacitive hand free automatic mixing faucet as claimed in claim 1, wherein said control device is selectively set to control the operation of said electronic valves separately or synchronously.

9. The capacitive hand free automatic mixing faucet as claimed in claim 1, further comprises a power source selected from the group of power adapter, storage battery, fuel battery, water power generator and solar cell and electrically connected to said control device to provide said control device with the necessary working voltage.

10. The capacitive hand free automatic mixing faucet as claimed in claim 1, wherein said at least one capacitive sensor group includes multiple capacitive sensor groups arranged at one same component of said flow passage and electrically isolated from one another, or separately arranged at different component parts of said flow passage.

11. The capacitive hand free automatic mixing faucet as claimed in claim 1, wherein said spout is movable; when said spout is connected to said flow passage, said at least one capacitive sensor group is connected to said spout or isolated from one another in said flow passage by insulator means; when said spout is separated from said flow passage, said at least one capacitive sensor group is isolated and does no work.

12. A capacitive hand free automatic mixing faucet, comprising:
a spout;
a flow passage connected to said spout, said flow passage defining a cold water passage connected to a cold water source and a hot water passage connected to a hot water source;
a temperature sensor installed in said flow passage and adapted for sensing the temperature of water passing from said flow passage to said spout;
a plurality of capacitive sensor groups mounted at an outer surface of said flow passage and adapted for sensing the presence of an external object and producing a corresponding inductance value;
a plurality of electronic valves respectively installed in said cold water passage and said hot water passage and controllable to regulate the flow rate of cold water passing from said cold water source through said cold water passage toward said spout and the flow rate of hot water passing from said hot water source through said hot water passage toward said spout;
a plurality of check valves respectively installed in said cold water passage and said hot water passage; and
a control device electrically connected with said capacitive sensor groups and said temperature sensor and adapted for receiving the inductance values produced by said capacitive sensor groups and the temperature value produced by said temperature sensor and controlling said electronic valves to regular the flow rate of cold water and the flow rate of hot water subject to the inductance values received from said capacitive sensor groups and the temperature value received from said temperature sensor.

13. The capacitive hand free automatic mixing faucet as claimed in claim 12, wherein said control device receives the induction values from said capacitive sensor groups and computes the sum of the inductance values or difference between the inductance values received within a predetermined time interval and compares the computed value with a predetermined first threshold value and a predetermined second threshold value, and gives no control when the computed value is smaller than said predetermined first threshold value, or controls said electronic valves to maintain their current operating status when the computed value is greater than said predetermined second threshold value, or switches said electronic valves between an open position and a close position when the computed value is within the range between said predetermined first threshold value and said predetermined second threshold value.

14. The capacitive hand free automatic mixing faucet as claimed in claim 12, wherein said control device receives every induction value from said capacitive sensor groups and compares each received inductance value with a predetermined inductance threshold value and starts counting time when the received inductance value surpasses the predetermined inductance threshold value, and then compares the counted time value with a predetermined first time threshold value and a predetermined second time threshold value, and then controls said electronic valves to maintain their current operating status or to regulate the flow rate of cold water or hot water when the counted time value is smaller than said predetermined first time threshold value or greater than said predetermined second time threshold value, or controls said electronic valves to switch between an open position and a close position when the counted time value is within the range between said predetermined first time threshold value and said predetermined second time threshold value.

15. The capacitive hand free automatic mixing faucet as claimed in claim 12, wherein said control device receives the induction values from said capacitive sensor groups and gives a different response mode subject to the sequence of said capacitive sensor groups that surpass the predetermined threshold value, and the different response mode is to regulate the flow rate of hot water or to regulate the flow rate of cold water; said temperature sensor provides a stabilized water temperature value to said control device so that when the user uses the capacitive hand free automatic mixing faucet in the next time, said controller controls said electronic valves automatically to the stabilized water temperature value subject to said temperature sensor till that the water temperature value detected by said temperature sensor is equal to the set water temperature value.

16. The capacitive hand free automatic mixing faucet as claimed in claim 12, wherein said control device receives the induction values from said capacitive sensor groups and gives a different response mode subject to the sequence of the capacitive sensor groups that surpass the predetermined threshold value, and the different response mode is to regulate the flow rate.

17. The capacitive hand free automatic mixing faucet as claimed in claim 12, wherein said electronic valves are proportional valves or motor valves, having functions of regulating water flow rate and switching on/off the supply of water.

18. The capacitive hand free automatic mixing faucet as claimed in claim 12, further comprises a power source selected from the group of power adapter, storage battery, fuel battery, water power generator and solar cell and electrically connected to said control device to provide said control device with the necessary working voltage.

19. The capacitive hand free automatic mixing faucet as claimed in claim 12, wherein said capacitive sensor groups are arranged at one same component of said flow passage and electrically isolated from one another, or separately arranged at different component parts of sad flow passage.

20. The capacitive hand free automatic mixing faucet as claimed in claim 12, wherein said spout is movable; when said spout is connected to said flow passage, said at least one capacitive sensor group is connected to said spout or isolated from one another in said flow passage by insulator means; when said spout is separated from said flow passage, said at least one capacitive sensor group is isolated and does no work.
